(19) United States
(12) Patent Application Publication
(10) Pub. No.: US 2024/0267736 A1
(43) Pub. Date: Aug. 8, 2024

(54) System and Method Implementing an Architecture for Trusted Edge IoT Security Gateways

(71) Applicant: CARNEGIE MELLON UNIVERSITY, Pittsburgh, PA (US)

(72) Inventors: Amit VASUDEVAN, Pittsburgh, PA (US); Matthew McCORMACK, Pittsburgh, PA (US); Vyas SEKAR, Pittsburgh, PA (US)

(73) Assignee: CARNEGIE MELLON UNIVERSITY, Pittsburgh, PA (US)

(21) Appl. No.: 18/565,745

(22) PCT Filed: Jun. 22, 2022
(86) PCT No.: PCT/US2022/034447

§ 371 Date: Nov. 30, 2023

Related U.S. Application Data
(60) Provisional application No. 63/214,493, filed on Jun. 24, 2021.

(51) Int. Cl. H04W 12/108; H04W 12/106; H04W 84/18

(52) U.S. Cl. CPC H04W 12/108; H04W 12/106; H04W 84/18

(57) ABSTRACT

Disclosed herein is a system and method implementing a trusted IoT security gateway architecture, based on a microhypervisor, that provides a guarantee that the correct security protections are applied to each IoT device's network traffic at all times, including when under attack. The disclosed architecture provides robust trust properties to a broad range of legacy hardware platforms utilizing existing software with a reasonable performance overhead.

### RELATED APPLICATIONS

This application claims the benefit of U.S. Provisional Patent Application No. 63/214,493, filed Jun. 24, 2021, the contents of which are incorporated herein by reference.

### BACKGROUND OF THE INVENTION

The Internet of Things (IoT) describes a network of physical devices having embedded sensors, software and other components that allow the object to perform a task and connect and exchange data with other devices over the internet. These devices range from ordinary household objects to sophisticated industrial tools.

An increasing number of IoT devices are deployed into edge environments, from home networks to manufacturing floors. Unfortunately, these devices are plagued by a myriad of vulnerabilities, which attackers have been able to exploit as stepping stones into protected networks and as launch pads for other attacks. Consequently, these IoT devices pose a continuing threat to the security of edge networks.

Industry and academia have proposed securing potentially vulnerable IoT devices on edge networks with on-site security gateways. These “bolt-on” security gateways are designed to intercept all traffic to and from an IoT device and apply security protections via middleboxes at the network level (e.g., a firewall). These middleboxes can be used to implement “network patches” which mitigate a device's vulnerabilities without patching the device's software.

While bolt-on security gateways are gaining popularity and are a deployable solution, the fundamental question of the trustworthiness of the system providing the network level protections remains. As an example scenario, consider a smart factory with a plethora of IoT devices protected by multiple security gateways. The factory's security gateways provide network level protections tailored to each individual IoT device's vulnerabilities. Unfortunately, security gateways form a single point of failure. They are particularly vulnerable to an adversary who can compromise the security gateway (by exploiting OS and/or application vulnerabilities), as the gateway typically runs commodity software (e.g., Linux, Docker, OVS, Snort, etc.). Once compromised, an adversary can modify the gateway's protections (e.g., remove a firewall rule) thereby enabling attacks against an IoT device to stop/alter production.

Current approaches for securing applications in untrusted cloud environments could potentially be applied to establish trust in security gateways. These approaches rely on hardware specific capabilities (e.g., SGX, MPX). Unfortunately, such approaches have high performance overheads, rendering them impractical for IoT deployments. They also lack generality, being limited to a specific processor class, and only support user space applications with constrained memory allocation. Furthermore, addressing security vulnerabilities requires fabricating newer revisions of the hardware.

### SUMMARY OF THE INVENTION

Disclosed herein is a system and method implementing a trusted IoT security gateway architecture that provides an overarching guarantee that the correct security protections are applied to each IoT device's network traffic at all times, including when under attack. The disclosed architecture provides robust trust properties to a broad range of legacy hardware platforms utilizing existing software with a reasonable performance overhead.

As disclosed herein, a microhypervisor-based approach is used as an architectural basis for building trust in edge security gateways. A microhypervisor, like a traditional hypervisor, is a software reference monitor that provides core security capabilities (e.g., memory isolation, mediation, and attestation) that can be applied to effectively address the aforementioned challenges. In contrast to traditional hypervisors, a microhypervisor provides these capabilities with a dramatically reduced trusted computing base (TCB) and complexity which enables formal verification to rule out potential vulnerabilities. Furthermore, microhypervisors provide an extensible foundation for realizing robust trust properties without a loss of generality and minimal performance overhead. Lastly, in contrast to approaches using specific hardware capabilities which limit applications (e.g., SGX's limitations previously described), microhypervisors can support a variety of hardware platforms (e.g., x86, ARM, microcontroller) running unmodified software (e.g., Linux). Thus, a microhypervisor provides a practical and secure foundation for building security mechanisms.

Heretofore, microhypervisors have not been used in edge IoT gateways. As such, the novelty of this invention is derived from a more holistic system adversary model for an edge IoT security gateway and a high-level architecture based on microhypervisors to enable a practical and flexible solution.

### BRIEF DESCRIPTION OF THE DRAWINGS

FIG. 1 is a schematic drawing illustration various attack vectors associated with an IoT device.

FIG. 2 is a high-level block diagram of a trusted, extensible, and widely-deployable edge security gateway architecture.

FIG. 3 is a high-level block diagram of the architecture's stack on a data plane implementation.

### DETAILED DESCRIPTION

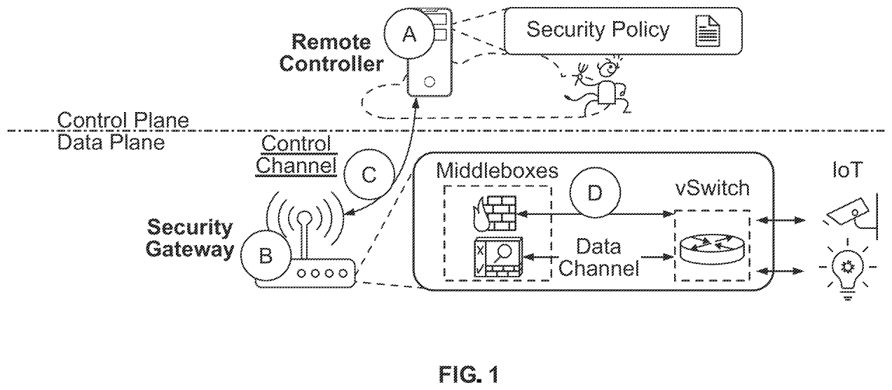

FIG. 1 shows various attack vectors from which bolt-on security architectures are vulnerable. An attacker could launch attacks at multiple points in the architecture. For example, an attacker could: (1) use an unpatched exploit to compromise the gateway itself (“B”) and (2) modify the middlebox configuration such that it allows the attacker's traffic to pass through to enable the attacker to compromise a factory's IoT device and steal proprietary data. Beyond modifying the software, an attacker could also tamper with network messages. For example, modifying packets on the data channel between the vSwitch and the middlebox (“D”), redirecting traffic to the wrong middlebox, evading security inspections. A trusted security architecture needs to protect the gateway and controller's software while prohibiting tampering with network traffic.

To address these various attack vectors, disclosed herein is a system and methods implementing a trusted, extensible, and widely-deployable edge security gateway architecture that addresses the security challenges of today's edge IoT deployments.

The design space can be categorized along two axes. First, approaches dependent on hardware functionality are limited in both the hardware platforms and software they can support. Additionally, their security properties rest on a complex and opaque implementation in microcode and silicon, known to have vulnerabilities. Second, pure software approaches (e.g., formal verification, secure programming languages) are limited as they require significant reimplementation and verification effort. As many commonly used software applications on edge security gateways span over 100,000 lines of C/Java this quickly becomes intractable.

It is dangerous to tie critical security features to either hardware implementations that require new hardware to address threats, or to software approaches that require significant reimplementation or formal verification effort of the entire software stack. Instead, the present architecture leverages legacy hardware features in combination with a small TCB and extensible software framework to provide fundamental trust properties and protect edge devices from evolving threats.

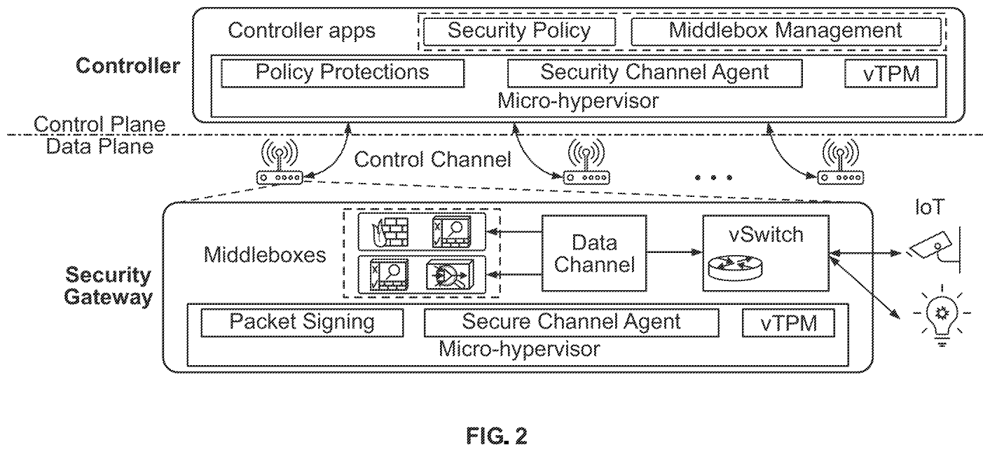

Consequently, a microhypervisor-based approach is disclosed herein to enable a trusted edge security gateway architecture, shown in FIG. 2, that retrofits security protections to only the necessary system components. A microhypervisor is in essence a software reference monitor that acts as a guardian, implementing access control to system resources (e.g., files, sockets) using a small TCB. These protections can be applied in a fine-grained manner, protecting a single data value (e.g., secret key) or a complex set of objects (e.g., a virtual machine) with minimal performance overhead. Microhypervisors provide a strong foundation for fine-grained mediation, isolation, and attestation with a small TCB, which allows for security services to be designed and implemented as extensions.

Due to their simplicity and small TCB, microhypervisors are amenable to formal verification for ruling out potential vulnerabilities within their code. Additionally, microhypervisors can potentially be supported on any hardware platform. The invention is built on top of the aforementioned microhypervisor-enabled foundational capabilities to construct a trusted security gateway architecture. The software of the controller and gateway run on top of a microhypervisor, thereby supporting any commodity OS and application stack. On the controller, critical data (e.g., the security policy) is migrated into microhypervisor extensions to isolate it from untrusted software (e.g., the OS). Further, all access is mediated by the microhypervisor, prohibiting an attacker from subverting the data's integrity.

On the gateway, a set of customized middleboxes is assigned to each device. The middleboxes are isolated from each other. Middleboxes are processing elements or virtual machines which are assigned to a single IoT device and which are attested on startup by the microhypervisor. Additionally, the signature of each middlebox and the vSwitch is periodically monitored to verify their integrity. Finally, the controller and the gateway run trusted agents, which are microhypervisor extensions used to mediate communication between the control and data planes, to ensure the instantiated protections correctly reflect the security policy.

The microhypervisor-based architecture provides three key benefits. First, it provides fine-grained isolation and mediation which allow for precisely ensuring that the architecture enforces the correct protections while being performant. Second, it is extensible allowing for rapid growth of new security functionality and response to emerging threats. Third, it is widely-deployable, supporting a wide range of hardware platforms while utilizing existing software, with a low performance overhead for providing trust.

There are three challenges that the disclosed architecture addresses: (1) Necessary Security Properties: Identify the security properties that ensure trust under a holistic adversary model; (2) Support Dynamic Middleboxes: Enable protecting the dynamic middleboxes required by an IoT environment, ensuring an adversary cannot modify the protections; and (3) Secure Communications: Provide per-packet protections with a low performance impact, guaranteeing an adversary cannot modify or spoof packets. The key building blocks of the architecture that address these requirements will now be discussed.

Adversary and Trust Properties: The goal is to provide end-to-end protections against a holistic threat model. Within the SDN domain, this would entail protecting both the control plane and the data plane (e.g., from BGP hijacking). However, prior works on IoT security gateways have typically only considered a narrow threat model.

To this end, such an adversary systematically defined with a goal of inhibiting the gateway's protections (i.e., enable exploiting a protected IoT device). It is assumed that the adversary has knowledge of the security architecture as well as network access to all devices. Adversary capabilities are grouped into two categories: (1) the ability to compromise a device's software stack (i.e., software on the controller or gateway: “A” and “B” in FIG. 1), and (2) the ability to inject/modify network messages (i.e., the control, data channels: “C” and “D” in FIG. 1).

A set of adversary capabilities are summarized in Table 1. These capabilities inhibit the architecture's ability to protect an IoT device and, when taken together, form an adversary model.

TABLE 1

| Example Threat | Vector | Violates |
|---|---|---|
| Modify controller software | A | P_{sw1}, P_{sw2} |
| (e.g., security policy) | | |
| Modify gateway software | B | |
| (e.g., middlebox config) | | |
| Spoof command (e.g., | A or B | P_{sw3} |
| add routing rule) | | |
| Spoof control channel | C | P_{comm4} |
| message (e.g., vSwitch route) | | |
| Tamper with data channel | D | P_{comm5} |
| message (e.g., skip middlebox) | | |

While not a complete list, the example threats in Table 1 are used to define the fundamental security properties needed for the trusted architecture. Based upon the adversary model in Table 1, there are a minimum of five fundamental properties required for a trusted security gateway architecture.

Software Integrity (Psw1): The ability to detect code and data modifications (e.g., changes in middlebox configuration).

Data Isolation (Psw2): The ability to isolate security critical logic (e.g., keep the OS from accessing the security policy).

Data Mediation (Psw3): The ability to have a trusted entity mediate access to security critical data (e.g., blocking an untrusted application's access to secret keys).

Secure Control Channel (Pcomm1): The ability to trust data transferred between the controller and gateway (e.g., the gateway only executes commands from the controller).

Secure Data Channel (Pcomm2): The ability to trust that packets are routed through the correct middleboxes (e.g., packets should not be processed by a wrong middlebox).

The architecture may support additional adversarial properties, but focuses on these five as being fundamental to a trusted architecture. These fundamental properties can be grouped into: (1) protecting running code (Psw) and (2) protecting communications (Pcomm).

### Supporting Dynamic Middleboxes

Ideally, the entire codebase on both the control and data planes of the IoT device could be robustly protected from an attacker. However, this is impractical as it either incurs significant performance costs (e.g., multiple enclaves to process each packet) or requires significant reimplementation (e.g., migrating 100,000+ lines of C/Java). Instead, fine-grained security properties are applied to the portions of the codebase that impact the architecture's protections, thereby creating a robustness against an adversary. Specifically, periodic, remote attestations are applied to guarantee the code's integrity (providing Psw1). This allows the code to run with minimal performance degradation, while bounding the duration it is vulnerable to attack. Additionally, critical code (e.g., security policy) can be protected with a hypervisor extension to isolate it (providing Psw2) and mediate access to it (providing Psw3).

Periodic, Remote Attestation: IoT security gateways rely upon a large codebase to provide device-specific protections. Prior methods of remote attestation, such as Trusted Platform Modules (TPM), are used to precisely guarantee that the appropriate software stack is running (providing Psw1). Upon boot, the correct baseline software stack, composed of the microhypervisor, OS, and critical software components (e.g., controller, vSwitch, middleboxes, etc.) is verified.

Subsequently, new modules that will impact the provided protections (e.g., the code of a new middlebox prior to loading) are attested, thereby allowing the architecture to ensure that the correct protections are instantiated.

During runtime, critical modules (e.g., controller, vSwitch, middleboxes) are periodically re-attested, thereby ensuring an attacker has not tampered with them. For example, the middlebox code must be run outside of the hypervisor to enable high packet throughput. To bound the potential impact of an attacker tampering with this code (i.e., the protection not being applied), the controller remotely attests critical software components on the gateway at the end of every epoch, where the epoch duration can be adjusted to provide a trade-off between the vulnerable window's length and the security overhead.

A virtual trusted platform module (vTPM) on the microhypervisor is leveraged to provide this attestation capability. A vTPM is a software implementation of a physical TPM and provides many of the same capabilities. Specifically, its ability to securely store a chain of measurements, by extending a program control register (PCR), and securely providing those stored values (i.e., a PCR quote) is used. These two capabilities enable determining if a software stack on a local or a remote machine matches a known configuration. These vTPM measurements can be applied at a fine granularity, with separate storage for multiple measurements.

Protecting the Controller's Security Policy: While attestation can provide significant guarantees about a code's integrity, there are some pieces of code that merit further protection (e.g., code impacting decisions about the protections provided by the security gateway). The microhypervisor approach enables selectively isolating this code (Psw2) and requiring that access to it be mediated by a trusted entity (Psw3). Examples of such pieces of code are the secret keys used to establish a secure control channel between the planes and the security policy on the controller.

As a concrete example, consider the controller's security policy. The security policy is critical to ensuring the correct protections are implemented (e.g., modifying it could result in the gateway's middleboxes not protecting the IoT devices). This code can be extracted from the controller and placed into memory isolated by the microhypervisor (providing Psw2). Further, access to this memory is mediated by the code white-list of the microhypervisor (providing Psw3), to ensure that only the controller's code can access the security policy.

This combination prohibits an attacker in control of the operating system from accessing and modifying microhypervisor-protected pieces of code, without requiring significant changes to existing code.

### Secure and Efficient Communication

The security architecture requires trust guarantees on both the control channel (between controller and gateway, Pcomm1) and the data channel (along the gateway's packet processing path, Pcomm2). The microhypervisor is used to provide isolation and mediation to secure these communication channels.

Secure Control Channel: It is crucial that communication between the control plane and the data plane can be trusted as these messages often impact the security protections provided by the gateway. The architecture bolsters the guarantees provided by traditional tunneling (e.g., IPsec/TLS) between the controller and the gateway to ensure a compromised controller or gateway cannot send spoofed messages over the tunnel (e.g., malicious middlebox configuration commands). To protect these communications (Pcomm1), a trusted agent pair running in the microhypervisor is used to mediate these communications (e.g., access the secret keys required to send data over this channel).

There is an agent on the controller and a corresponding agent on the gateway, which together are responsible for mediating access to the secure channel.

Secure Data Channel: On the data plane, the security protections are dependent upon each packet being processed by the correct middlebox. The architecture provides per-hop guarantees with a low performance overhead. Specifically, the goal is to guarantee that packets follow the correct path and are processed by the correct sequence of middleboxes on the data plane (Pcomm2). While traditional tunnels could be established between each middlebox and the vSwitch, this would result in significant overhead and processing delays. To protect the data channel, the microhypervisor is used to enforce the correct path (i.e., middlebox chain) for each packet. This is achieved by having the microhypervisor sign and verify each packet along its processing path and dropping packets that fail verification. This approach differs from prior per-hop authentication proposals as packets remain on a single host where a hypervisor can maintain secret keys.

These digital signatures create a connection between the raw packet data and the middlebox processing the packet, by the secret key (protected by the microhypervisor) shared between the vSwitch and each middlebox. Furthermore, the digital signatures can be trusted, as the secret keys are kept in isolated memory only accessible by the microhypervisor's mediation, stopping an attacker from forging signed packets.

### Implementation

An exemplary embodiment will now be disclosed. In one embodiment, the uberXMHF open source microhypervisor that supports both x86 and ARM platforms is used. A Raspberry Pi 3 hardware platform can be used to execute the uberXMHF microhypervisor, the Raspbian Jessie (Linux 4.4.y) and Open Virtual Switch and Snort on the gateway.

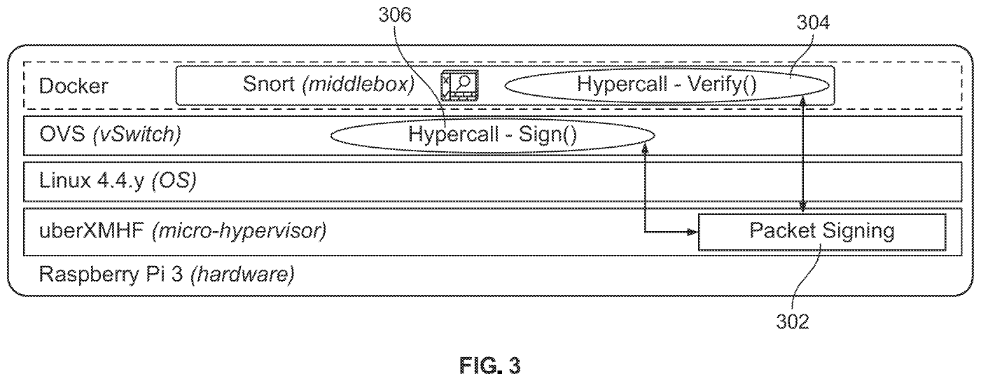

A high-level overview of the software stack of the implementation is shown in FIG. 3 where the hypervisor extension 302 is depicted as the rectangle labelled “Packet Signing”. Ovals 304, 306 represent hypercalls to the hypervisor extension 302, added to the commodity software to perform a hypervisor protected operation (e.g., creating/verifying a digital signature for a packet). These elements of the architecture implementation are exemplary only and, as would be realized, implementation using other elements are contemplated to be within the scope of the invention.

Virtual Trusted Platform Module (vTPM): The architecture leverages a hypervisor-enabled vTPM to provide periodic, remote attestation. A key motivation in the development of Trusted Platform Modules (TPM) was to provide the ability to remotely attest the health of a system's boot sequence. A subset of the features provided by the TPM standard are leveraged to provide trust properties, specifically PCR extend and PCR quote. In addition to a vTPM not requiring additional hardware, it provides two key benefits over a physical TPM, increased storage and increased performance. The measurement storage (i.e., PCRs) on a vTPM is based upon the platform's memory region protected by the microhypervisor, allowing for a large number of separate measurements (e.g., >200 PCRs on a single 4 KB page). Furthermore, these measurements are not limited by the data rate of a system bus (e.g., SPI on a Raspberry Pi 3), reducing access latency by over 20×. A challenge for software-based TPMs is preserving secrets across reboots. The vTPM leverages existing platform non-volatile memory to preserve secrets across boots (e.g., the Raspberry Pi 3 has a boot NVRAM that can act as a long-term secure storage).

In one embodiment, the architecture may be implemented as a trustworthy “security-as-a-service” offering that providers (e.g., edge ISPs, CDNs, IoT providers) could offer to IoT consumers, ensuring the correct security protections are applied at all times. For instance, the architecture provides a trusted mechanism for enforcing IoT security best practices (e.g., access-control policies in a device's manufacturer usage description specification).

As would be realized by one of skill in the art, the disclosed systems and methods described herein can be implemented by a system comprising a processor and memory, storing software that, when executed by the processor, performs the functions comprising the method. For example, the training, testing and deployment of the model can be implemented by software executing on a processor.

As would further be realized by one of skill in the art, many variations on implementations discussed herein which fall within the scope of the invention are possible. Specifically, many variations of the architecture of the model could be used to obtain similar results. The invention is not meant to be limited to the particular exemplary model disclosed herein. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A system for providing a secure environment for IoT devices comprising:
a controller defining a control plane for the IoT device, the controller executing software that is either protected by or attested by a controller microhypervisor; and
a security gateway defining a data plane, the security gateway including one or more middleboxes and a vSwitch attested by a security gateway microhypervisor.

2. The system of claim 1 wherein the controller and security gateway microhypervisors include a trusted computing base.

3. The system of claim 2 wherein the controller comprises:
one or more controller apps;
a security policy; and
middlebox management software;
wherein the security policy and middlebox management software are protected by executing in memory partitioned by the controller microhypervisor.

4. The system of claim 3 wherein the one or more middleboxes and the vSwitch execute on the security gateway outside of the security gateway microhypervisor.

5. The system of claim 4 wherein each IoT device has one or more middleboxes assigned solely thereto.

6. The system of claim 5 wherein the controller, the middleboxes and the vSwitch are periodically re-attested.

7. The system of claim 1 wherein the controller microhypervisor and the security gateway microhypervisor each comprise a trusted platform module.

8. The system of claim 7 wherein the trusted platform modules are virtual.

9. The system of claim 7 wherein the trusted platform modules are used to determine if a software stack implementing the controller, the middleboxes and the vSwitch matches a known configuration.

10. The system of claim 7 when the controller microhypervisor and the security gateway microhypervisor further comprise a secure channel agent.

11. The system of claim 10 wherein the controller microhypervisor and the security gateway microhypervisor each further comprise a secure channel agent to establish and mediate access to secure channels of communication between the controller and the security gateway.

12. The system of claim 10 wherein the security gateway microhypervisor performs a packet signing function to verify data packets are processed by a correct sequence of middleboxes.

13. The system of claim 12 were in the packet signing function utilize digital signatures.

14. The system of claim 13 wherein the digital signatures comprise one or more secret keys shared between the vSwitch and each middlebox.

15. The system of claim 11 wherein code implementing the secure channel agents and the TPMs are isolated and access to the code is mediated by the controller microhypervisor and the security gateway microhypervisor.
